(19) United States
(12) Patent Application Publication
(10) Pub. No.: US 2012/0256995 A1
(43) Pub. Date: Oct. 11, 2012

(54) Method and Device for Printing at Least One Printing Substrate

(75) Inventors: Stefan HOLZER, Emmendingen (DE); Armin Gerland, Haeg-Ehrsberg (DE); Peter Geiger, Teningen (DE)

(73) Assignee: THIEME GmbH & Co. KG, Teningen (DE)

(21) Appl. No.: 13/437,571

(22) Filed: Apr. 2, 2012

(30) Foreign Application Priority Data
Apr. 7, 2011 (DE) 10 2011 006 929.1

(51) Int. Cl. B41J 2/00

(52) U.S. Cl. 347/110

(57) ABSTRACT

A method and device are provided for printing at least one printing substrate on a printing support, more particularly a printing table, by use of a digital printing unit. The method feeds the printing substrate onto the printing table, detects the position of the printing substrate on the printing table, and aligns a print image produced by the digital printing unit in accordance with the detected position of the printing substrate.

### CROSS-REFERENCE TO RELATED APPLICATIONS

This application claims priority under 35 U.S.C. §119 from German Patent Application No. DE 10 2011 006 929.1, filed Apr. 7, 2011, the entire disclosure of which is herein expressly incorporated by reference.

### BACKGROUND AND SUMMARY OF THE INVENTION

The invention relates to a method for printing at least one printing substrate on a printing support, more particularly a printing table, by way of a digital printing unit. The invention also relates to a device for printing at least one printing substrate, which device includes a printing table for the accommodation of a printing substrate and a digital printing unit for producing a print image on the printing substrate, and a control unit for controlling the digital printing unit.

In prior methods employed for printing substrates by use of a digital printing unit or with prior devices having a digital printing unit, a printing substrate to be printed, for example a sheet of paper, is laid on the printing table and secured in a required position on the printing table by use of stop members. In the case of large printing tables, it is usually possible to apply a negative pressure to the surface of the printing table in order to fix the position of the printing substrate on the printing table, thus rendering it immovable during the printing operation. The register, that is to say, the exact required position of the print image on the printing substrate, is ensured by aligning the printing substrate at a defined position and printing at the defined position of the printing substrate.

Alignment of the printing substrate is carried out manually or mechanically. The material to be printed is caused to approach so-called locating pins, which are raised at this point and which mechanically stop the movement of the material to be printed. A vacuum is then applied to the surface of the printing table and the material to be printed is retained in its position against the locating pins. This manual or mechanical alignment of the printing substrate is time-consuming and results in positioning errors of the print image on the printing substrate when the alignment is not carried out with sufficient precision.

When modern digital printers are used in commercial companies, it is desirable to utilize the entire surface of the printing table during each printing operation. This increases productivity and also makes it possible to print different motifs in different quantities and in different formats in one operation cycle. The requirement to position a plurality of printing substrates and accordingly the requirement to align each individual printing substrate exactly demands precision and, in the case of manual alignment of the printing substrate, the concentration of the operator. On the one hand, this aligning procedure constitutes a source of error and, on the other hand, will always consume time for positioning and aligning the printing substrates. In the case of very large printing tables, the dimensions of the printing table are beyond the reach of the operator for the purpose of positioning the printing substrates so that the aligning operation is further complicated.

The object of the invention is to improve a method and a device for printing at least one printing substrate by way of a digital printing unit.

According to the invention, there is provided for this purpose a method for printing at least one printing substrate on a printing support, more particularly a printing table, by way of a digital printing unit, which method provides for the transport of the printing substrate onto the printing support, the detection of a position of the printing substrate on the printing support, and the alignment of a print image produced by the digital printing unit in accordance with the detected position of the printing substrate.

By means of the invention, it is possible to position the printing substrate arbitrarily on the printing support. In the method of the invention, it is of no consequence when the printing substrate is not located at its exact predefined position on the printing support, since the position of the printing substrate on the printing support will be first detected and then the print image produced by the digital printing unit will be aligned with the detected position of the printing substrate. This ensures that at all times the print image will be in register with the printing substrate. Thus, apart from reducing the time taken to position the printing substrates on the printing support, it is possible to eliminate sources of error, since exact alignment is not required. It may also be possible to economize on constructive positioning aids such as locating pins. For example, a printing table or alternatively a conveyor belt can be used as the printing support. For example, printing tables may be designed to be movable such that printing substrates can be positioned at a first position of the printing table and the printing table then moved to a second position below the printing unit. The position of the printing substrate is then detected by a camera or a scanner during the movement of the printing table. The invention can also be used in stationary digital printing units in which the printing table is moved relative to the printing unit or printing units during the printing operation. Finally, positions for the printing substrate or for a plurality of printing substrates on the printing table need not be predetermined exactly, according to the invention, as a result of which there is increased flexibility of the method with respect to formats, sizes, and shapes of media to be printed. Thus, the product range can be expanded while achieving the highest possible productivity.

According to the invention, the printing substrates require no, or only rough, alignment on the printing support. In order to ensure that the print image is in register with the printing substrate, use is made of devices for detecting the position, shape, size, and/or location of the printing substrates, for example by use of image processing, for transferring the acquired information to a control unit for the printing unit and for printing the print image on the printing substrate by use of the printing unit in accordance with the detected position of the printing substrate.

In a development of the invention, the position of the at least one printing substrate on the printing support is acquired by optical detection.

Optical detection is readily achieved, for example, by use of a camera and suitable image processing software. It is also possible, for example, to provide optical sensors in the surface of the printing support to detect the presence of a printing substrate.

In a development of the invention, provision is made for detecting the format of the at least one printing substrate.

By detecting the format of the printing substrate, it is possible to check, for example, whether a print image to be produced is suitable for the printing substrate. It is also possible, for example, to select and carry out one of several pending print jobs in accordance with the detected format of the printing substrate. In this way, the format of the printing substrates disposed on the printing support can be recognized by way of software, and pending print jobs can then be assigned to these printing substrates until the current print jobs have been completed. It is likewise possible to scale the print image produced by the digital printing unit to match the detected format of the printing substrate.

In a development of the invention, provision is made for detecting the format, at least one side length, the shape, the location of the center of the printing substrate and/or the alignment of the printing substrate on the printing table.

The detection of such parameters contributes toward an additional improvement of the method of the invention. For example, substrates of arbitrary shape such as a polygon shape or a free shape such as a Christmas tree shape or alternatively a piece of furniture can be printed on the printing substrates such that the print image is in exact register therewith.

In a development of the invention, provision is made for controlling the devices for generating a negative pressure on the surface of the printing support in accordance with the detected position and/or the detected format of the printing substrate.

In this way, a negative pressure can be applied only to those regions of the surface of the printing support in which the printing substrate is actually located. This measure conserves energy, since it is only necessary to generate the negative pressure in those regions in which the printing substrate needs to be retained.

In a development of the invention, provision is made for projecting marks onto the printing support at least during the feed-in of the at least one printing substrate.

In this way, a manual feed of printing substrates can also be facilitated without the provision of mechanical locating devices such as locating pins. For example, laser lines or even print images can be projected onto the surface of the printing support in order to facilitate approximate alignment of the printing substrates when they are fed onto the printing support.

The object of the invention can also be achieved by a device for printing at least one printing substrate, which device comprises a printing support, more particularly a printing table, for accommodating a flat printing substrate, and a digital printing unit for producing a print image on the printing substrate, and also a control unit for controlling the digital printing unit, which control unit comprises at least one detector for the purpose of detecting the position of the printing substrate on the printing support, and said control unit also comprises an alignment device that aligns the print image produced by the printing unit in accordance with the detected position of the printing substrate.

In a development of the invention, at least one camera is provided for the purpose of detecting the position of the printing substrate on the printing support.

In a further development of the invention, there are provided at least one device for generating a negative pressure on the surface of the printing support and a controller for controlling the device(s) in accordance with the detected position, in accordance with the detected format, in accordance with at least one detected side length, in accordance with the detected shape, in accordance with the detected location of the center of the printing substrate and/or in accordance with the detected alignment of the printing substrate on the printing support.

In a still further development of the invention, devices are provided for projecting marks onto the printing support.

Additional features and advantages of the invention are revealed in the claims and the following description of preferred embodiments of the invention with reference to the drawings. Individual features of the various embodiments shown can be combined in an arbitrary manner without going beyond the scope of the invention.

### BRIEF DESCRIPTION OF THE DRAWINGS

FIG. 1 is a diagrammatical top view of a printing table with printing substrates positioned thereon,

FIG. 2 shows the printing table shown in FIG. 1 on completion of image processing,

FIG. 3 shows the printing table shown in FIG. 1 with print images produced on the printing substrates, and

FIG. 4 is a diagrammatical illustration of an exemplary device according to the invention.

### DETAILED DESCRIPTION OF THE DRAWINGS

The illustration shown in FIG. 1 is a diagrammatical top view of a printing table 10 on which there is positioned a plurality of printing substrates 11, 12, 13, 14, 15, 16, 17, 18, 19, 20, 21, and 22 of various formats. As can be seen in the figure, the printing substrates 11 to 22 are arbitrarily positioned and their respective side edges are not aligned so as to be parallel or at right angles to each other. In a conventional device for printing the printing substrates 11 to 22, this would result in the respective print images and the printing substrates 11 to 22 not being in register with each other, that is to say, the print images would not be positioned at their respectively desired positions relative to the printing substrates 11 to 22.

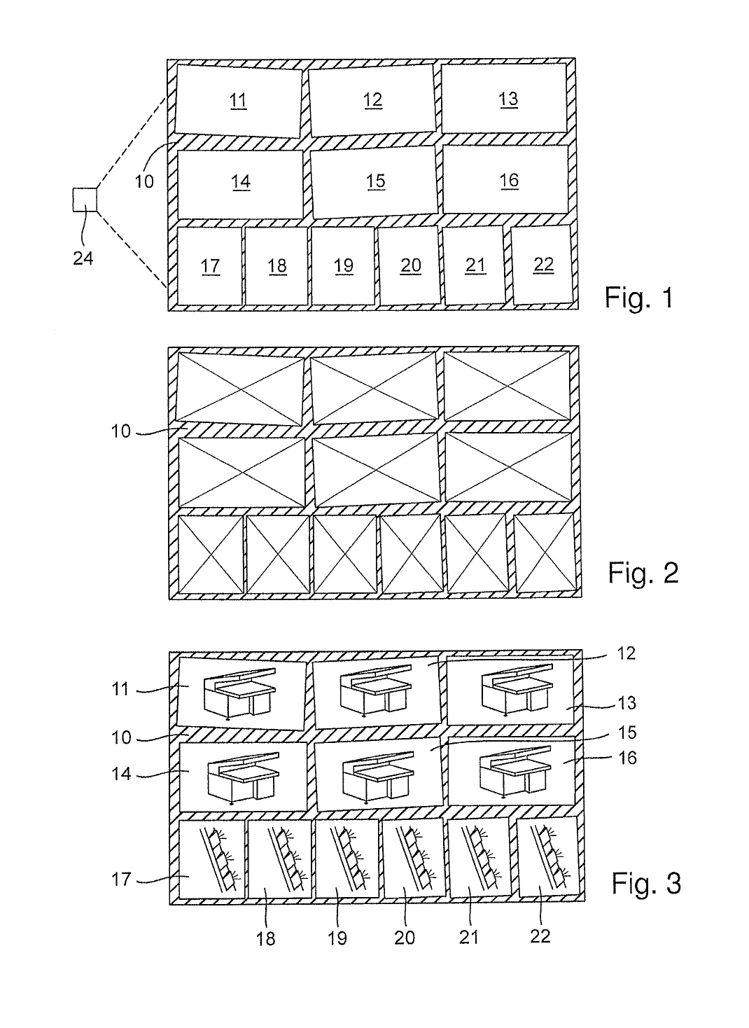

According to an embodiment of the invention, there is provided a camera 24, which is shown purely diagrammatically in FIG. 1, and by which the positions of the printing substrates 11 to 22 on the printing table 10 are detected. The respective contours of the printing substrates 11 to 22 are in fact detected by the camera 24, and the optical signals detected are processed by image processing software in a control unit to give the image of the printing table 10 shown in FIG. 2. As shown by diagonals on the printing substrates 11 to 22 in FIG. 2, the respective side lengths of the printing substrates 11 to 22, their format, for example DIN A4 or DIN A5, and the location of the center of each printing substrate 11 to 22 and the alignment of each substrate 11 to 22 in terms of the angle between the side edges of each printing substrate 11 to 22 and the side edges of the printing table 10 are now known to the control unit.

For the purposes of the invention it is merely essential for the position of each printing substrate 11 to 22 relative to the printing table 10 to be made known, in order to make it possible to align a print image to be produced on the printing substrates 11 to 22 in accordance with the position detected and to ensure that the print image is in register with the printing substrate. However, the parameters by which this position of the printing substrates 11 to 22 relative to the printing table 10 is detected, for example, the corner points of each printing substrate 11 to 22, the side lengths and the location of the centers of the printing substrates 11 to 22 or the like, are insignificant.

The illustration shown in FIG. 3 shows the printing substrates 11 to 22 on the printing table 10 with the print images produced thereon. As can be seen in the figure, the print images produced are each in alignment with the detected position of the printing substrates 11 to 22, according to the invention, so that all of the print images have now been printed so as to be in exact register and exactly aligned with the respective printing substrate 11 to 22.

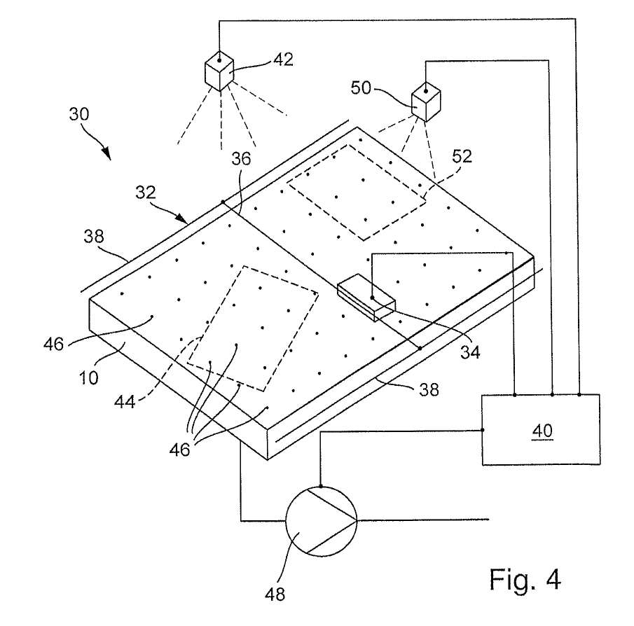

The illustration shown in FIG. 4 is a diagrammatic representation of an exemplary device 30 according to the invention for the printing of substrates. The device 30 comprises a printing table 10 and a printing unit 32 having a print head 34 that can be moved along a rail 36 transversely across the printing table 10. The rail 36 can in turn be moved along two parallel rails 38 across the printing table in order to enable the print head 34 to print substantially over the entire surface of the printing table 10. The print head 34 and devices (not shown in FIG. 4) for moving the print head 34 along the rail 36 and for moving the rail 36 along the rails 38 are controlled by a central control unit 40 of the device 30.

The printing device 30 further comprises a camera 42 that makes it possible to detect the surface of the printing table 10 on which the substrate to be printed is to be placed. A printing substrate positioned on the surface of the printing table 10 is indicated purely diagrammatically by the reference numeral 44 by means of dash lines in the illustration shown in FIG. 4. The position of the printing substrate 44 on the surface of the printing table 10 is detected by the camera 42 and, on completion of appropriate image processing in the control unit 40, the control unit 40 controls the print head 34 and devices (not shown in the figure) for moving the print head over the surface of the printing table 10 such that the print image to be produced will be aligned with the position of the printing substrate 44 detected by the camera. The print image is then positioned in exact alignment with the printing substrate 44.

The surface of the printing table 10 is provided with numerous orifices 46 through which a negative pressure can be applied by way of a pump 48. The generation of a negative pressure in the region of the orifices 46 serves to fix the position of a printing substrate, for example the printing substrate 44 positioned on the surface of the printing table 10, during a printing operation. The pump 48 and devices (not shown in the figure) disposed inside the printing table 10 for controlling the individual orifices 46 are likewise controlled by the control unit 40. The control unit 40 ensures that negative pressure is applied to only those orifices 46 that are located beneath a printing substrate 44 as detected by the camera 42. In the illustration shown in FIG. 4, a negative pressure would thus be applied to substantially only those orifices 46 which are located within the rectangle indicated by dash lines and denoting the printing substrate 44.

In order to facilitate the rough alignment of the printing substrate 44 when it is manually positioned on the printing table, there is provided a laser 50 that is controlled by the control unit 40. Laser lines 52 indicating a required position of the printing substrate 44 can be projected onto the surface of the printing table 10 by use of the laser 50. The laser lines 52 are indicated by dot-dash lines in FIG. 4. Thus, the laser lines 52 are projected onto the surface of the printing table 10 by use of the laser 50 before the printing substrate 44 is positioned on the printing table. An operator can then slide the printing substrate 44 and, if required, other printing substrates, to the positions predetermined by the laser lines 52. In doing so, it is not necessary for the operator to align the printing substrate 44 exactly with the laser lines 52, since the position of the printing substrate 44 will be detected by the camera 42 prior to the printing operation, and the control unit will then align the print image to be produced with the position of the printing substrate 44 as detected by the camera.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for printing at least one printing substrate on a printing support using a digital printing unit, the method comprising the acts of:
feeding the printing substrate onto the printing support;
detecting a position of the printing substrate on the printing support; and
aligning a print image produceable by the digital printing unit in accordance with the detected position of the printing substrate on the printing support.

2. The method according to claim 1, wherein the printing support is a printing table.

3. The method according to claim 1, wherein the detecting act is carried out by optically detecting the position of the printing substrate on the printing support.

4. The method according to claim 1, wherein the detecting act detects a format of the printing substrate.

5. The method according to claim 4, further comprising the act of
selecting and executing one of a plurality of pending print jobs in accordance with the detected format of the printing substrate.

6. The method according to claim 5, further comprising the act of:
scaling the print image produceable by the digital printing unit in accordance with the detected format of the printing substrate.

7. The method according to claim 4, further comprising the act of:
scaling the print image produceable by the digital printing unit in accordance with the detected format of the printing substrate.

8. The method according to claim 1, wherein the detecting act further comprises the act of detecting at least one of a format, at least one side length, a shape, a position of a center of the printing substrate, and an alignment of the printing substrate, on the printing support.

9. The method according to claim 8, further comprising the act of
controlling a generation of negative pressure on a surface of the printing support in accordance with at least one of the detected position and detected format of the printing substrate on the printing support.

10. The method according to claim 1, further comprising the act of:
projecting marks onto the printing support at least during the feeding of the printing substrate.

11. A device for printing at least one printing substrate, comprising:
a printing support for accommodating a flat printing substrate;
a digital printing unit operatively configured to produce a print image on the printing substrate accomodated on the printing support;
a control unit operatively configured to control the digital printing unit; and
a detection unit that detects a position of the printing substrate on the printing support; and
wherein the control unit is operatively configured to align the print image produced by the digital printing unit in accordance with the detected position of the printing substrate.

12. The device according to claim 11, wherein the detection unit comprises at least one camera operatively configured to image the position of the printing substrate on the printing support.

13. The device according to claim 12, further comprising:
a negative pressure generation device that generates a negative pressure on a surface of the printing support; and
wherein the control unit is operatively configured to control the negative pressure generating device in accordance with at least one of the detected position, a detected format, at least one detected side length, a detected shape, a detected position of a center of the printing substrate, and a detected alignment of the printing substrate, on the printing support.

14. The device according to claim 11, further comprising:
a negative pressure generation device that generates a negative pressure on a surface of the printing support; and
wherein the control unit is operatively configured to control the negative pressure generating device in accordance with at least one of the detected position, a detected format, at least one detected side length, a detected shape, a detected position of a center of the printing substrate, and a detected alignment of the printing substrate, on the printing support.

15. The device according to claim 11, further comprising:
a projecting unit operatively configured to project marks onto the printing support, the projecting unit being operatively coupled with the control unit.

16. The device according to claim 12, further comprising:
a projecting unit operatively configured to project marks onto the printing support, the projecting unit being operatively coupled with the control unit.

17. The device according to claim 14, further comprising:
a projecting unit operatively configured to project marks onto the printing support, the projecting unit being operatively coupled with the control unit.
